(19) United States
(12) Patent Application Publication
(10) Pub. No.: US 2007/0071207 A1
(43) Pub. Date: Mar. 29, 2007

(54) Facsimile apparatus and error call monitoring apparatus

(75) Inventors: Satoru Kashiwada, Sagamihara-shi (JP); Masaki Kakutani, Hiratsuka-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/339,272

(22) Filed: Jan. 25, 2006

(30) Foreign Application Priority Data
Sep. 21, 2005 (JP) JP2005-273831

(51) Int. Cl. H04M 3/00

(52) U.S. Cl. 379/188

(57) ABSTRACT

There are described an facsimile apparatus and a monitor apparatus, which make it possible to prevent occurrence of an error call for an unintended receiver or destination and to provide information effective for investigating the cause of the error call. The facsimile apparatus includes: a telephone number input section which accepts an input of a telephone number information for a destination; a dial signals detection section which detects dial signals to be transmitted on a telephone line; a comparison section which compares a first telephone number represented by the dial signals detected by the dial signals detection section with a second telephone number represented by the telephone number information inputted at the telephone number input section; and a control section which disconnects the telephone line based on a comparison result of the comparison section in case that the first telephone number and the second telephone number are different.

### RELATED APPLICATION

This application is based on Japanese Patent Application NO. 2005-273831 filed on Sep. 21, 2005 in Japanese Patent Office, the entire content of which is hereby incorporated by reference.

### BACKGROUND

1. Field of the Invention

The present invention relates to a prevention of error call in a facsimile apparatus.

2. Description of the Related Art

When a sender tries to transmit an original document via a facsimile apparatus, sometimes, the original document is erroneously sent to an unintended receiver, which is not recognized by the sender. To prevent such the error call, various kinds of technologies have been proposed so far.

For instance, to prevent an operator from inputting erroneous telephone number, a telephone number inputted at a time of calling is temporally stored in a dialing buffer, and then, the telephone number is compared with telephone numbers registered in advance in a telephone number storing section, so as to confirm an existence of a telephone number coinciding with the inputted telephone number or an existence of a telephone number approximate to the inputted telephone number. When confirming the existence of the telephone number coinciding with the inputted telephone number, the inputted telephone number stored in the dialing buffer is determined to be correct, and the calling operation is actually conducted. While, when confirming the existence of the telephone number approximate to the inputted telephone number, the approximate telephone number is displayed on a screen to give a warning to the operator. The facsimile apparatus employing the abovementioned technology is set forth in, for instance, Patent Document 1.

Further, to prevent erroneous transmitting operations except between the facsimile apparatuses approved of each other, the facsimile apparatus of the sender side transmits image data, which includes a special code representing the terminal device of the receiver side embedded into a predetermined area of the image data, to the receiver. Then, when the image data are received, the facsimile apparatus of the receiver side determines whether or not the special code included in the image data coincides with the special code allotted to the terminal device itself. When the special code does not coincide with the allotted special code, the facsimile apparatus of the receiver side disconnects the communication of the image data. The facsimile apparatus employing the abovementioned technology is set forth in, for instance, Patent Document 2.

[Patent Document 1]
Tokkaihei 5-7237 (Japanese Non-Examined Patent Publication)

[Patent Document 2]
Tokkaihei 6-334826 (Japanese Non-Examined Patent Publication)

The causes of the erroneous transmission in which the original document is transmitted to the unintended receiver, which is not recognized by the sender, are roughly categorized into: <1> operation errors committed by the operator (namely, an erroneous dialing of a telephone number, an error of pushing one-touch key, an error of pushing abbreviated dialing, etc.); <2> registration errors of abbreviated dialing (an error in registration number of one-touch key or abbreviated dialing, committed at the time of the registration); <3> apparatus malfunctions (malfunctions caused by hardware factors and/or software factors); and further, <4> confused cases in which the sending operation conducted by another facsimile apparatus coupled to the external telephone terminal of the facsimile apparatus concerned is confused with an error call committed by the facsimile apparatus concerned.

According to the technology set forth in Patent Document 1, by comparing the inputted telephone number with the corresponding telephone number registered at the abbreviated dialing storage, etc., for instance, one digit error could be detected to give a warning to the user. Therefore, such the technology is effective for the input error of the telephone number among the errors in the abovementioned category <1>, but ineffective for the pushing error of the one touch key or the inputting error of the abbreviated dialing number, etc. Further, it has been impossible to cope with the abovementioned categories <2>-<4>.

According to the technology set forth in Patent Document 2, it is necessary that both the facsimile apparatus equipped at the sender side and the other facsimile apparatus equipped at the receiver side should be provided with the function in regard to the special code, which is not specified as the standard protocol. Accordingly, it has been inevitably impossible to prevent erroneous transmissions between facsimile apparatuses whose manufacturers are different from each other. Further, even if the erroneous transmissions can be prevented, the information for solving the problems with respect to the erroneous transmissions have not been provided.

Actually, when an incident presumably regarded as the error call occurs in the market, the cause of the incident is investigated according to the procedure indicated as follow. Whether or not the cause is “the operation error committed by the operator as indicated by abovementioned category <1>” has been determined by referring the calling history data stored in the facsimile apparatus. Whether or not the cause is “the registration error as indicated by abovementioned category <2>” has been determined by confirming the registration data stored in the facsimile apparatus.

Whether or not the cause is “the apparatus malfunction as indicated by abovementioned category <3>” has been determined by comparing a communication history acquired from a carrier, such as a telephone company, etc., with the calling history data stored in the facsimile apparatus. In the case of abovementioned category <4>, sometimes, the original document has been actually transmitted to the receiver side, though no calling history data with respect to the error call concerned are stored in the facsimile apparatus. Accordingly, as well as the case of abovementioned category <3>, the cause of abovementioned category <4> has been determined by comparing a communication history acquired from the telephone company with the calling history data stored in the facsimile apparatus or in the externally-coupled facsimile apparatus.

With respect to the case of abovementioned category <3> or <4>, it is necessary to acquire the communication history from the telephone company, etc. However, due to the protection of the personal information, etc., only the user can acquire the communication history from the telephone company. Accordingly, there has been a problem that the manufacturer or the seller would give the user, to be requested for acquiring the communication history from the telephone company, a lot of trouble, and if the user refuses the acquisition or the delivery of communication history, it becomes impossible for the manufacturer or the seller to investigate the cause of the error call.

### SUMMARY

To overcome at least one of the abovementioned drawbacks in conventional facsimile apparatus and error call monitoring apparatus, it is an object of the present invention to provide a facsimile apparatus and an error call monitoring apparatus, which make it possible to prevent occurrence of an error call for an unintended receiver or destination.

Further, it is another object of the present invention to provide a facsimile apparatus and an error call monitoring apparatus, which make it possible to provide information effective for investigating the cause of the error call, when an event to be presumably regarded as an error call happens.

In view of foregoing, an object of this invention is to solve at least one of the problems, and to provide new facsimile apparatus and new monitor apparatus. The facsimile apparatus comprises

a) a telephone number input section which accepts an input of a telephone number information for a destination;

b) a dial signals detection section which detects dial signals to be transmitted on a telephone line;

c) a comparison section which compares a first telephone number represented by the dial signals detected by the dial signals detection section with a second telephone number represented by the telephone number information inputted at the telephone number input section; and

d) a control section which disconnects the telephone line based on a comparison result of the comparison section in case that the first telephone number and the second telephone number are different.

According to another aspect of the present invention, the facsimile apparatus comprises

e) a telephone number storage section which stores a destination information and a telephone number information in association with each other;

f) a selection section which selects a desired telephone number information from the telephone number information stored in the telephone number storage section;

b) a dial signals detection section which detects dial signals to be transmitted on a telephone line;

c) a comparison section which compares a first telephone number represented by the dial signals detected by the dial signals detection section with a second telephone number represented by the telephone number information selected at the selection section; and

d) a control section which disconnects the telephone line based on a comparison result of the comparison section in case that the first telephone number and the second telephone number are different.

According to another aspect of the present invention, the facsimile apparatus comprises

a) a telephone number input section which accepts an input of a telephone number information for a destination;

b) a dial signals detection section which detects dial signals to be transmitted on a telephone line;

g) a control section which controls to store a first telephone number represented by the dial signals detected by the dial signals detection section and a second telephone number represented by the telephone number information inputted at the telephone number input section.

According to another aspect of the present invention, the facsimile apparatus comprises

e) a telephone number storage section which stores a destination information and a telephone number information in association with each other; and

f) a selection section which selects a desired telephone number information from the telephone number information stored in the telephone number storage section,

b) a dial signals detection section which detects dial signals to be transmitted on a telephone line;

g) a control section which controls to store a first telephone number represented by the dial signals detected by the dial signals detection section and a second telephone number represented by the telephone number information selected at the selection section.

According to another aspect of the present invention, the monitor apparatus for an error call request comprises

a telephone number obtaining section which obtains from a facsimile apparatus a telephone number information for a destination;

a dial signals detection section which detects dial signals to be transmitted from the facsimile apparatus to a telephone line;

a comparison section which compares a first telephone number represented by the dial signals detected by the dial signals detection section with a second telephone number represented by the telephone number information obtained at the telephone number obtaining section; and

a control section which disconnects the telephone line based on a comparison result of the comparison section in case that the first telephone number and the second telephone number are different.

According to another aspect of the present invention, the monitor apparatus for an error call request comprises

a telephone number obtaining section which obtains from a facsimile apparatus a telephone number information for a destination;

a dial signals detection section which detects dial signals to be transmitted from the facsimile apparatus to a telephone line;

a control section which controls to store a first telephone number represented by the dial signals detected by the dial signals detection section with a second telephone number represented by the telephone number information obtained at the telephone number obtaining section.

The invention itself, together with further objects and attendant advantages, will best be understood by reference to the following detailed description taken in conjunction with the accompanying drawings.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a brief configuration of a facsimile apparatus embodied as the first embodiment of the present invention;

FIG. 2 shows a brief configuration and a flowchart of data processing in regard to a calling operation in a facsimile apparatus embodied as the first embodiment of the present invention;

FIG. 3 shows an example of a circuit configuration of a NCU block being a combination of a NCU and an error call monitoring section; and

FIG. 4 shows a block diagram of an error call monitoring apparatus embodied as the second embodiment of the present invention.

### DETAILED DESCRIPTION OF THE PREFERRED EMBODIMENT

Referring to the drawings, various kinds of embodiments embodied in the present invention will be detailed in the following.

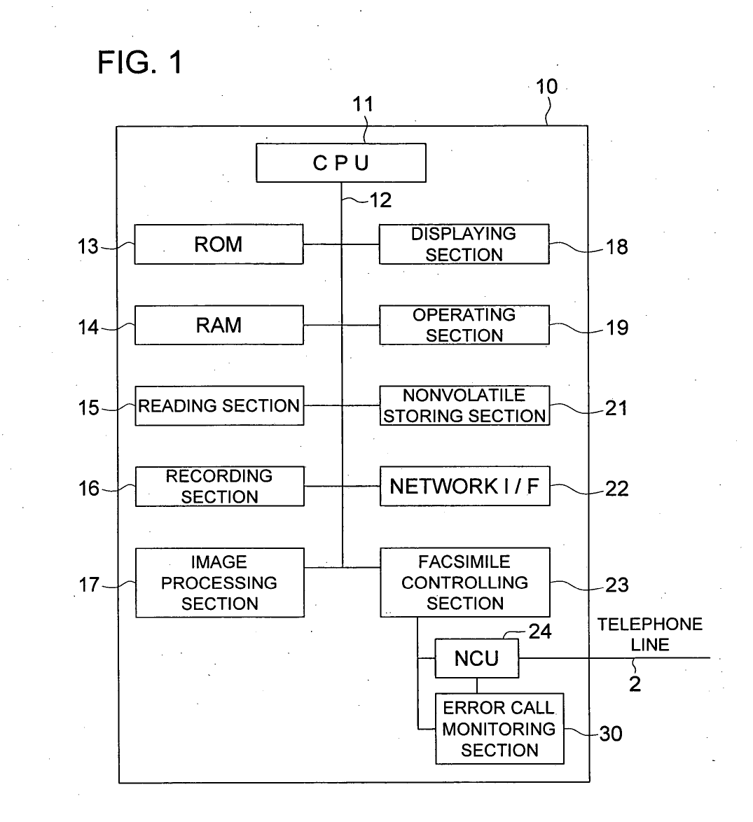

FIG. 1 shows a brief configuration of a facsimile apparatus 10 embodied as a first embodiment of the present invention. The facsimile apparatus 10 is provided with a CPU 11 (Central Processing Unit 11) serving as a controlling device for totally controlling the operation of the facsimile apparatus 10. The CPU 11 is coupled to a ROM 13 (Read Only Memory 13), a RAM 14 (Random Access Memory 14), a reading section 15, a recording section 16, an image processing section 17, a displaying section 18, an operating section 19, a nonvolatile storing section 21, a network I/F 22 (network interface 22) and a facsimile controlling section 23. Further, a NCU 24 (Network control Unit 24) and an error call monitoring section 30 are coupled to the facsimile controlling section 23.

The programs to be executed by CPU 11 and various kinds of fixed data are stored in ROM 13. While, the RAM 14 serves as a working memory for temporally storing various kinds of data and/or as an image memory for temporally storing an image data when the CPU 11 executes the program.

The reading section 15 has a function of reading an original document to acquire image data of the original document. The reading section 15 is provided with a light source for irradiating light onto the original document, a line image sensor for reading one line information of the original document in its width direction, a moving mechanism for moving the original document in its length direction to shift it in a unit of every one line, an optical path including mirrors and lenses for guiding and focusing the light reflected from the original document to/onto the line image sensor. The line image sensor is constituted by CCD (Charge Coupled Device), etc. The analogue image signals outputted by the line image sensor is converted to digital data through the analogue to digital converting processing, so as to output the digital data as digital image data.

The recording section 16 has a function for forming an image on a recording paper, based on the digital image data. In this embodiment, the recording section 16 is configured as a laser printer, which includes a conveying device of the recording paper, a photoreceptor drum, a charging device, a laser unit, a developing device, a transfer separation device, a cleaning device and a fixing device, so as to form an image through the electro-photographic process.

The image processing section 17 has functions for enlarging/reducing the image, rotating the image, applying the error diffusion processing for quasi-representing the multi-gradation image with binary data, etc.

The displaying section 18 has a function for displaying various kinds of guiding information, status information, warning messages, etc. A liquid crystal display, etc. could be employed as the displaying section 18. The operating section 19 has a function for receiving various kinds of operation commands and instructions inputted by the user. In this embodiment, the operating section 19 is constituted by a touch panel formed on the surface of the liquid-crystal display and various kinds of operation switches. The nonvolatile storing section 21 is such a storage that can hold the stored data as it is even if the power switch is turned OFF. Various kinds of registration information, communication histories are stored in the nonvolatile storing section 21.

Incidentally, the operating section 19 serves as a telephone number inputting section when information of the telephone number of a receiver are inputted. Further, the nonvolatile storing section 21 serves as a telephone number storing section for storing addresses and the telephone number information while correlating them with each other. Still further, the operating section 19 serves as a selecting section for selecting specific telephone number information from the telephone number information stored in the telephone number storing section. Concretely speaking, the addresses and the telephone number information can be registered in the nonvolatile storing section 21 for every abbreviated dialing number or every one-touch key while correlating them with each other. Accordingly, by inputting the abbreviated dialing number or operating the one-touch key from the operating section 19, it is possible to select a specific one from the telephone number information of the receivers stored in advance.

The network I/F 22 has a communicating function for coupling external terminal devices, such as personal computers, etc., to the facsimile apparatus 10 through a LAN (Local Area Network). It is possible for the facsimile apparatus 10 to receive a command of facsimile transmission job and image data to be transmitted on the basis of the received command, from the external terminal device through the network I/F 22, and to transmit the image data. As mentioned in the above, when receiving the facsimile transmission job via the LAN, the information of the telephone number, the abbreviated dialing number and the one-touch key number for specifying the receiver are included in the command of facsimile transmission job. Accordingly, the network I/F 22 serves as the functions of the telephone number inputting section and the selecting section. Further, there would be a case that the facsimile apparatus 10 receives a command of facsimile transmission job with image data from an external facsimile apparatus via the telephone network, as well. In this case, the NCU 24 serves as the function of the telephone number inputting section.

Based on the protocol of facsimile transmission, the facsimile controlling section 23 conducts various kinds of controlling operations for executing the facsimile transmission with the remote apparatus of the other party. The facsimile controlling section 23 is provided with a CPU (not shown in the drawings), which controls the communicating procedure. The NCU 24 is coupled to a telephone line 2, so as to transmit dial signals onto the telephone line 2, to detect an arrival signal and to modulate/demodulate the signals. The error call monitoring section 30 serves as a dial signal detecting section, which detects the dial signals transmitted onto the telephone line 2 by the NCU 24 so as to monitor and/or prevent an error call for another party unrecognized by the user.

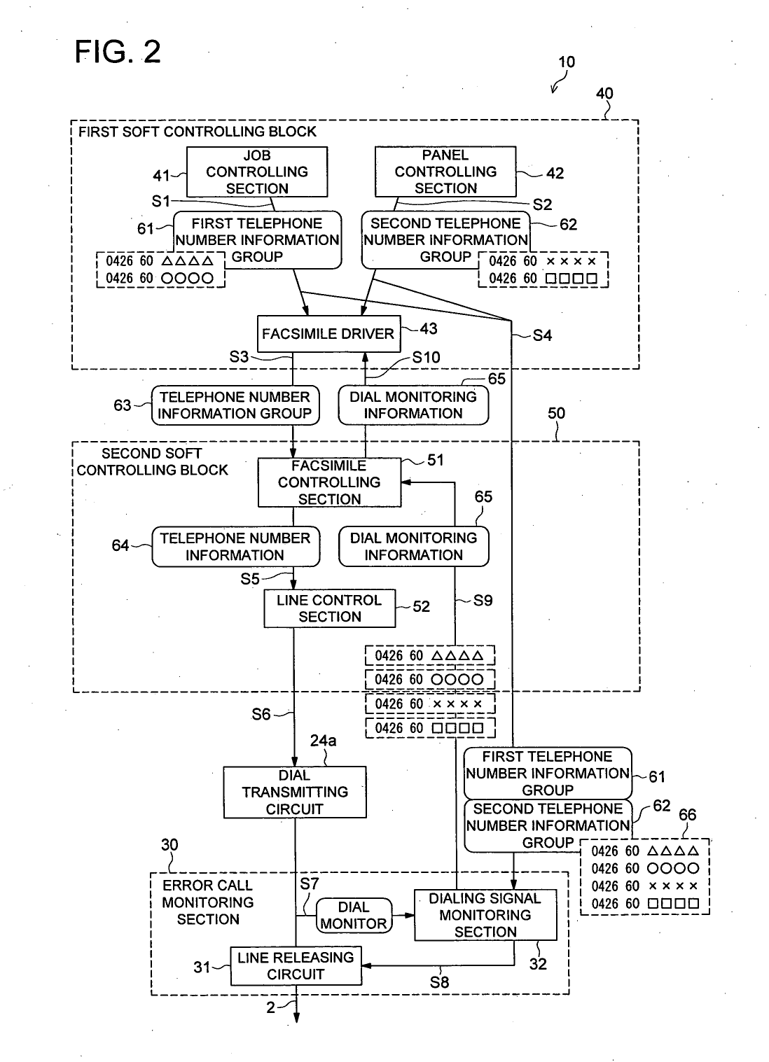

FIG. 2 shows a brief configuration and a flowchart of processing in regard to a calling operation in the facsimile apparatus 10. The facsimile apparatus 10 is provided with a first soft controlling block 40, a second soft controlling block 50, a dial transmitting circuit 24a and the error call monitoring section 30, as sections pertaining to the calling operation.

The first soft controlling block 40 has functions for controlling the telephone number information of the receiver when conducting the facsimile transmission, and for totally controlling the implementation of the job. The first soft controlling block 40 includes a job controlling section 41, a panel controlling section 42 and a facsimile driver 43. The job controlling section 41 conducts a total controlling operation with respect to the implementation of the job. The panel controlling section 42 controls operations of the displaying section 18 and the operating section 19. The facsimile driver 43 conducts interfacing operations to the second soft controlling block 50.

The second soft controlling block 50 includes a facsimile controlling section 51 and a line control section 52 to conduct controlling operations for the dial transmitting circuit 24a. The facsimile controlling section 51 conducts the communication controlling operations based on the protocol of the facsimile. The line control section 52 has a function for controlling the dial transmitting circuit 24a so as to implement the calling operation. The operations pertaining to the second soft controlling block 50 are mainly conducted in the facsimile controlling section 23.

The dial transmitting circuit 24a, which transmits the dial signals onto the telephone line 2 to implement the calling operation, is included in the NCU 24 shown in FIG. 1. The dial transmitting circuit 24a is so constituted that the calling operation can be implemented for both the pulse dialing method and the DTMF dialing method.

The error call monitoring section 30 is provided with a line releasing circuit 31 and a dial signal monitoring section 32. The line releasing circuit 31 is constituted by, for instance, relay circuits serially inserted into the telephone line 2, in order to forcibly release the telephone line 2. The dial signal monitoring section 32 serves as the dial signal detecting section for detecting the dial signals transmitted onto the telephone line 2 by the dial. transmitting circuit 24a, a comparing section for comparing the first telephone number, represented by the dial signals detected, with the second telephone number indicated by the telephone number information inputted via the telephone number inputting section or selected by the selecting section (namely, the telephone number of the receiver instructed by the user) so as to determine whether or not the first and second telephone numbers coincide with each other, and a controlling section for controlling the line releasing circuit 31 so as to release the line when the first and second telephone numbers mentioned in the above do not coincide with each other. Incidentally, instead of the above, it is also applicable that the CPU has both the comparing function for determining whether or not the first and second telephone numbers coincide with each other and/or the line releasing function.

The error call monitoring section 30 is so constituted that the dial signals of both the pulse dialing method and the DTMF dialing method can be detected.

Next, referring to FIG. 2, a flow of the calling operation conducted in the facsimile apparatus 10 will be detailed in the following.

When receiving a request of the facsimile transmission job, the first soft controlling block 40 receives a designation of the telephone number information of the receiver. The method for designating the telephone number includes: (a) directly inputting it through the operating section 19 by the user; (b) selecting it from the telephone numbers registered in advance by operating the one touch key or inputting the abbreviated dialing number; (c) receiving it from the external apparatus through the network I/F 22. It is possible to designate a plurality of receivers (the broadcast transmission function) at the time of one facsimile transmission job, and to receive the designation of receivers designated by arbitrarily combining the three methods mentioned in the above.

In the example shown in FIG. 2, the first soft controlling block 40 receives a first telephone number information group 61 inputted by operating the one touch key or inputting the abbreviated dialing number (S1), and also receives a second telephone number information group 62 directly inputted from the operating section 19 (S2). Then, the first telephone number information group 61 and the second telephone number information group 62 are combined and arranged into one group to create a telephone number information group 63, which is successively transferred to the second soft controlling block 50 from the facsimile driver 43 (S3). In the process of creating the telephone number information group 63, a processing for reducing the same telephone numbers, which are doubly designated in the two groups, into one telephone number, and a processing for arranging the telephone numbers according to a predetermined rule are applied to the combination of the first telephone number information group 61 and the second telephone number information group 62.

Further, the first soft controlling block 40 also transmits the first telephone number information group 61 and the second telephone number information group 62 to the dial signal monitoring section 32 of the error call monitoring section 30, without applying such the processing mentioned in the above (S4). This transmitting operation is conducted through a transmitting path independent of the creation and transmission of the telephone number information group 63 (namely, this operation is an independent task on the software). The dial signal monitoring section 32 registers the first telephone number information group 61 and the second telephone number information group 62 in a number registration table 66 to store them in it.

Based on the telephone number information group 63 received from the first soft controlling block 40, the facsimile controlling section 51 of the second soft controlling block 50 implements the facsimile transmitting operation by calling one by one in order. Concretely speaking, the facsimile controlling section 51 sends specific telephone number information 64 selected from the telephone number information group 63 to the line control section 52 (S5). Then, the line control section 52 controls the dial transmitting circuit 24a to implement the calling action of the telephone number indicated by the telephone number information inputted from the facsimile controlling section 51 (S6).

The error call monitoring section 30 detects the dial signals transmitted onto the telephone line 2 by the dial transmitting circuit 24a (S7), in order to recognize the telephone number (the first telephone number) represented by the dial signals concerned. Then, the error call monitoring section 30 compares the first telephone number represented by the dial signals with the other telephone number (the second telephone number) indicated by the first telephone number information group 61 and the second telephone number information group 62 transmitted from the first soft controlling block 40. Concretely speaking, the error call monitoring section 30 determines whether or not the first telephone number represented by the dial signals coincides with any one of the telephone numbers registered in the number registration table 66. When determining that the first telephone number does not coincide with any one of the telephone numbers registered, the line releasing circuit 31 is controlled to release the line (S8).

The operation for releasing the line is completed prior to the operation for transmitting the image data to the receiver. Concretely speaking, the line is released from the facsimile apparatus 10 before the facsimile apparatus 10 enters into Phase C specified by T.30 recited in the facsimile transmission procedures. In this embodiment, since the operation for comparing the telephone numbers is conducted just after the dial signals are detected, in order to release the line as needed, the operation for releasing the line is conducted before the facsimile apparatus 10 enters into Phase B.

As described in the above, when an error call is detected, in which the telephone number information designated by the user is different from the telephone number represented by the dial signals to be actually transmitted to the line, since the line is released from the facsimile apparatus 10 before the image information are transmitted on the line, it becomes possible to eliminate such an erroneous transmission that the image information are erroneously transmitted to a wrong receiver, resulting in a prevention of the secrecy leakage, etc.

The error call would occur due to various kinds of causes, such as, for instance, a software processing error in the first soft controlling block 40 or the second soft controlling block 50, a malfunction of the dial transmitting circuit 24a, reflections and distortions of the dial signals caused by induced components generated in the PBX (Private Branch Box), etc., etc. In the present embodiment, since the first and the second telephone number information groups 61, 62, residing at the entrance where the user can designate the specific receiver, are compared with the telephone number residing at the outlet indicated by the dial signals to be actually transmitted onto the telephone line 2, it becomes possible to surely detect and prevent the error call, irrespective of any one of the steps from the entrance to the outlet in which the cause of the error call exists.

The dial signal monitoring section 32 transmits the first telephone number recognized from the detected dial signals to the second soft controlling block 50 as dial monitoring information 65 (S9). Then, the second soft controlling block 50 further transfers them to the first soft controlling block 40 (S10). Further, when the line is released, a notification of the line release is transferred to the first soft controlling block 40 through the second soft controlling block 50 (S9, S10).

The first soft controlling block 40 serves as a notifying section for notifying the user of the line release, when receiving the notification of the line release. In this embodiment, the fact of the line release is displayed on the displaying section 18. Further, in a predetermined case, an e-mail indicating the notification of the line release is transmitted to an external terminal device. For instance, when the facsimile transmission job under the line release is requested from the external terminal device through the network I/F 22, the e-mail notifying of the forced line release is transmitted to the e-mail address registered in advance while correlating it to the external terminal device concerned. It is also applicable that e-mail addresses of a maintenance manager, etc. are registered in advance so that the e-mail indicating notification of the line release is automatically transmitted to the e-mail addresses concerned. In addition, various kinds of notifying methods, such as generating a warning sound at the facsimile apparatus 10, outputting a communication report indicating the line release, etc., can be applicable as needed.

Further, the first soft controlling block 40 stores the dial monitoring information 65 (in regard to the first telephone number) transmitted from the error call monitoring section 30, and the first telephone number information group 61, the second telephone number information group 62 or the telephone number information group 63 (in regard to the second telephone number) into the nonvolatile storing section 21, while correlating them with each other. In this embodiment, the abovementioned information are stored as a history for every communication. Concretely speaking, information, correlated a communication start time, communication results (absence or presence of the line release caused by the error call, etc.), the first telephone number detected from the dial signals, the second telephone number designated by the user, etc. for every communication, can be stored as communication history information.

The communication history information stored in the nonvolatile storing section 21 can be not only outputted as a printed matter in a format of the communication journal, but also transmitted to the external terminal device. When an error call is suspected to occur, it is possible to utilize the communication history information for investigating the cause of the error call. Specifically, since the communication history information includes the comparison result between the first telephone number and the second telephone number, namely, the absence or presence of the line release, it becomes possible to easily retrieve and specify the communication in which the error call has occurred from the communication history information. For instance, it is preferable that a mark indicating the forced line release is printed onto the applicable position of the communication journal.

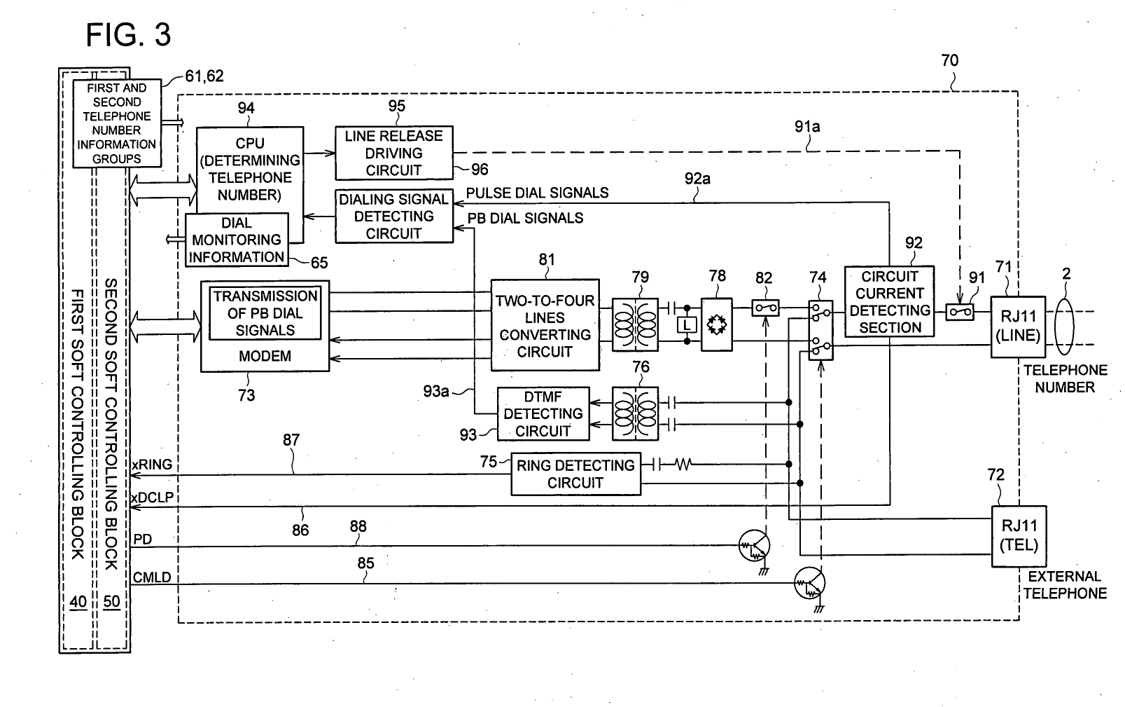

FIG. 3 shows an example of a circuit configuration of a NCU block 70 being a combination of the NCU 24 and the error call monitoring section 30. The NCU block 70 is provided with a line connection terminal 71 for connecting it to the telephone line 2, an external telephone connection terminal 72 for connecting it to an external telephone and a CML (Connect Modem to Line) relay 74, which is inserted into a path between the line connection terminal 71 and the external telephone connection terminal 72, for switching the telephone line 2, coupled to the line connection terminal 71, to either an internal circuit side, such as a modem 73, etc., or the external telephone connection terminal 72.

Based on the CMLD (CML relay driving) signal 85 sent form the second soft controlling block 50, the switching operation of the CML relay 74 is controlled in such a manner that the telephone line 2 is coupled to the external telephone connection terminal 72 in the normal state, while, only during a time period in which the facsimile apparatus 10 actually conducts the facsimile transmitting operation, the telephone line 2 is coupled to the internal circuit side, such as a modem 73, etc.

A line releasing relay 91 for forcibly releasing the telephone line 2 from the apparatus, and a circuit current detecting section 92 for detecting a direct current loop and dial signals according to the pulse dialing method are inserted into a path between the line connection terminal 71 and the CML relay 74. A result of detecting the direct current loop is inputted into the second soft controlling block 50 as a DCLP signal 86.

Further, a ring detecting circuit 75 and a transformer 76 are coupled in parallel to circuit lines between the CML relay 74 and the external telephone connection terminal 72, and a DTMF (Dial Tone Multi Frequency) detecting circuit 93 is coupled to a secondary winding of the transformer 76. The DTMF detecting circuit 93 has a function for detecting a signal sound called a pushing sound or a tone signal, being dial signals in the DTMF dialing method. The ring detecting circuit 75 outputs a predetermined RING signal 87 to the second soft controlling block 50 when detecting a signal receiving.

A bridge circuit 78, a transformer 79, a two-to-four lines converting circuit 81, etc. are inserted into a path between the CML relay 74 and the modem 73. Further, a PD relay 82, to be switched on and off for sending pulse dial signals, is serially inserted into a path between the CML relay 74 and the bridge circuit 78. According as PD controlling signals 88 inputted from the second soft controlling block 50, a contact point of the PD relay 82 is driven to turn on and off.

The modem 73 has functions for converting (modulating) the digital data to audio signals, which are transmittable on the telephone line 2, and for converting (demodulating) the audio signals received via the telephone line 2 to digital data. When calling in the DTMF dialing method, the modem 73 generates the dial signals (pushing sounds) to transmit them on the telephone line 2. Accordingly, in the pulse dialing method, the PD relay 82 performs the function of the dial transmitting circuit 24a shown in FIG. 2, while, in the DTMF dialing method, the modem 73 performs the function of the dial transmitting circuit 24a.

The NCU block 70 is further provided with a CPU 94, a line release driving circuit 95 and a dial signal detecting circuit 96. In response to a command sent from the CPU 94, the line release driving circuit 95 outputs driving signals 91a for driving the line releasing relay 91. Since both pulse dial signals 92a detected by the circuit current detecting section 92 and DTMF dial signals 93a detected by the DTMF detecting circuit 93 are inputted into the dial signal detecting circuit 96, the dial signal detecting circuit 96 recognizes the telephone number indicated by both dial signals 92a, 93a.

The line releasing relay 91 performs the function of the line releasing circuit 31 shown in FIG. 2, while the combination of the circuit current detecting section 92, the DTMF detecting circuit 93, the CPU 94, the line release driving circuit 95 and the dial signal detecting circuit 96 achieves the function of the dial signal monitoring section 32 shown in FIG. 2. Concretely speaking, the dial signal detecting circuit 96 serves as a dial signal detecting section for detecting dial signals transmitted on the telephone line 2. The CPU 94 serves as a comparing section for comparing the first telephone number, represented by the dial signals detected by the dial signal detecting circuit 96, with the second telephone number, indicated by the telephone number information inputted by the telephone number inputting section or selected by the selecting section, to determine whether or not the first and second telephone numbers coincide with each other, and also serves as a controlling section for releasing the line when the comparing section determines that the first and second telephone numbers do not coincide with each other as a result of the comparing operation mentioned in the above. To actually achieve the line releasing operation, the line release driving circuit 95 opens the line releasing relay 91, in response to the command sent from the CPU 94.

Prior to the start of the facsimile transmission, the first telephone number information group 61 and the second telephone number information group 62 are inputted into the CPU 94 from the first soft controlling block 40 through the second soft controlling block 50. Further, the CPU 94 transmits the dial monitoring information 65, representing the telephone number recognized from the pulse dial signals 92a and the DTMF dial signals 93a, and the notification of the line release to the second soft controlling block 50.

Since the comparing and determining processing in regard to the first telephone number indicated by both dial signals 92a, 93a detected and the second telephone number received from the first soft controlling block 40 is conducted by the CPU 94 being independent of the second soft controlling block 50, the comparing and determining processing itself prevent an erroneous operation from occurring in mutual relation with other software processing, resulting in an improvement of reliability of the error call detecting operation. Incidentally, instead of the CPU 94, it is also applicable that an independent logic circuit, etc. having the same function is employed for this purpose.

Further, it is desirable that dial signals residing on the telephone line 2 are always detected for monitoring, and when a certain kind of dial signals is detected, the comparison processing for comparing the first telephone number represented by the detected dial signals with the second telephone number designated by the user is conducted, and at the same time, the history of the first and second telephone numbers are stored in the apparatus. According to the abovementioned procedure, when another facsimile apparatus, coupled to the external telephone connection terminal 72 of the facsimile apparatus 10, commences the facsimile transmission, the dial signals are detected to recognize the first telephone number. However, since the telephone number information (the second telephone number) are not transmitted from the first soft controlling block 40, the first telephone number does not coincide with the second telephone number (blank), resulting in the line release. In addition, since a communication history, indicating that the first telephone number exists while the second telephone number does not exist, is stored, it becomes possible to confirm that the calling operation in regard to the communication history is not an error call committed by the facsimile apparatus 10, but is conducted by the other facsimile apparatus coupled to the external telephone connection terminal 72.

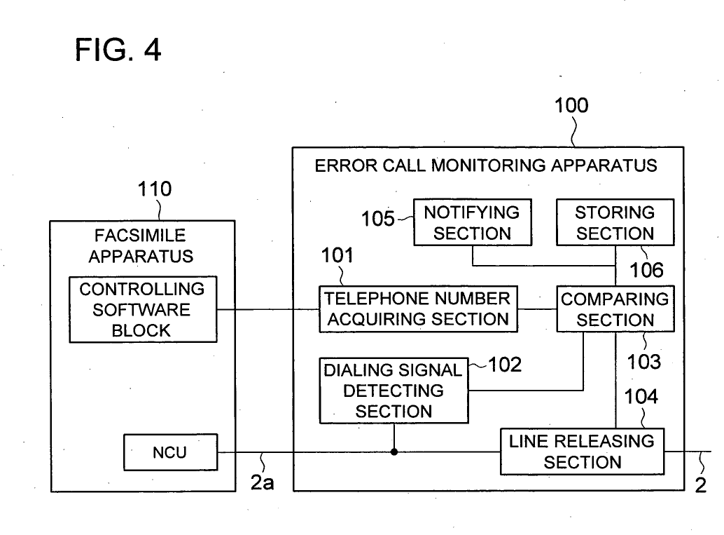

FIG. 4 shows a block diagram of an error call monitoring apparatus 100 embodied in the present invention as the second embodiment. The error call monitoring apparatus 100 is inserted into a path between a facsimile apparatus 110 and the telephone line 2. The error call monitoring apparatus 100 is so constituted that the functions equivalent to that of the error call monitoring section 30 shown in FIG. 2 are realized as an external apparatus.

The error call monitoring apparatus 100 is provided with a telephone number acquiring section 101 for acquiring a telephone number of a receiver from the facsimile apparatus 110, a dial signal detecting section 102 for detecting dial signals transmitted onto the telephone line 2 by the facsimile apparatus 110, a comparing section 103 for comparing the first telephone number detected by the dial signal detecting section 102 with the second telephone number represented by the telephone number information acquired by the telephone number acquiring section 101 to determine whether or not the first and the second telephone numbers coincide with each other, a line releasing section 104 for releasing the telephone line 2 from the facsimile apparatus 110 when the comparing section 103 determines that the first and the second telephone numbers do not coincide with each other, a notifying section 105 for notifying of the line release when the telephone line 2 is released, and a storing section 106 for storing monitoring histories.

Among the abovementioned sections, a combination of the telephone number acquiring section 101, the dial signal detecting section 102 and the comparing section 103 is equivalent to the dial signal monitoring section 32 shown in FIG. 2. Further, the line releasing section 104 is equivalent to the line releasing circuit 31 shown in FIG. 2. In the normal state, the facsimile apparatus 110 is coupled to the telephone line 2 through the line releasing section 104.

The error call monitoring apparatus 100 and the facsimile apparatus 110 are coupled to each other by employing an exclusive I/F (interface) for transmitting the telephone number information, etc. For instance, USB (Universal Serial Bus) I/F can be employed for this purpose. It is also applicable that the information, such as telephone number information, etc., are transmitted by using the telephone line 2 coupling the error call monitoring apparatus 100 and the facsimile apparatus 110 to each other. Concretely speaking, the transmission of the telephone number information can be achieved in such a manner that a modem modulates the telephone number information to be transmitted from the facsimile apparatus 110 to the error call monitoring apparatus 100 and transmits the modulated telephone number information onto a telephone line 2a, and then, the error call monitoring apparatus 100 demodulates the received information.

The dial signal detecting section 102 is constituted by the circuits, which are respectively equivalent to the circuit current detecting section 92, the DTMF detecting circuit 93 and the dial signal detecting circuit 96. The comparing section 103 is constituted by a CPU or an exclusive logic circuit. The notifying section 105 displays a message of the line release on the displaying section (not shown in the drawings). Alternatively, it is also applicable that the notifying section 105 notifies the facsimile apparatus 110 of the line release through a predetermined I/F section so that the message of the line release is displayed on the displaying section of the facsimile apparatus 110, or e-mail including a notification of the line release is sent to the external apparatus.

The storing section 106 includes a nonvolatile memory so as to store the first telephone number represented by the dial signals detected by the dial signal detecting section 102 and the second telephone number represented by the telephone number information acquired by the telephone number acquiring section 101 while correlating the first and second telephone numbers with each other. In this embodiment, the first and second telephone numbers are further correlated with the communication date, etc. to store them as a history for every communication. The information stored in the storing section 106 can be displayed on the displaying section of the notifying section 105. Alternatively, it is also applicable that the information are transmitted to the facsimile apparatus 110 through the predetermined I/F section in order to conduct displaying and/or printing operations of the information, or to transmit them to the external apparatus.

Prior to the commencement of the facsimile transmission, the facsimile apparatus 110 transmits the telephone number information to the error call monitoring apparatus 100. The telephone number acquiring section 101 of the error call monitoring apparatus 100 receives the telephone number information sent from the facsimile apparatus 110. Then, the dial signal detecting section 102 detects the dial signals transmitted onto the telephone line 2a by the facsimile apparatus 110, and the comparing section 103 compares the first telephone number detected by the dial signal detecting section 102 with the second telephone number represented by the telephone number information acquired from the facsimile apparatus 110 by the telephone number acquiring section 101, and when the first and second telephone numbers do not coincide with each other, the comparing section 103 makes the line releasing section 104 open to release the facsimile apparatus 110 from the telephone line 2. Further, when releasing the line, the notifying section 105 transmits the notification of the line release. The first and the second telephone numbers are stored in the storing section 106 for every communication as the communication history, and when releasing the line, the information of the line release are also stored in the storing section 106 while correlating the information with the first and the second telephone numbers.

By employing the error call monitoring apparatus 100 having the functions as mentioned in the above and externally attached to the facsimile apparatus 110, it becomes possible to monitor the occurrence of the error call in the facsimile apparatus 110 already installed. Incidentally, it is desirable that dial signals residing on the telephone line 2 are always detected for monitoring, and when a certain kind of dial signals is detected, the comparison processing for comparing the first telephone number represented by the detected dial signals with the second telephone number transmitted from the facsimile apparatus 110 is conducted, and at the same time, the history of the first and second telephone numbers are stored in the apparatus. According to the abovementioned procedure, when another facsimile apparatus, coupled to the external telephone connection terminal of the facsimile apparatus 110, conducts the facsimile transmission, since the second telephone number transmitted from the facsimile apparatus 110 does not exist (blank), though the first telephone number can be recognized, the first telephone number does not coincide with the second telephone number (blank), resulting in the line release. In addition, since a communication history, indicating that the first telephone number exists while the second telephone number does not exist (blank), is stored, it becomes possible to confirm that the calling operation in regard to the communication history is not an error call committed by the facsimile apparatus 110, but is conducted by the other facsimile apparatus coupled to the external telephone connection terminal of the facsimile apparatus 110.

Although the embodiments of the present invention have been detailed in the foregoing, referring to the drawings, the scope of the present invention is not limited to the embodiments exemplified in the foregoing, and it is to be understood that changes and variations may be made without departing from the spirit and scope of the present invention.

For instance, although the aforementioned embodiments are applicable for both the pulse dialing method and the DTMF dialing method, it is needless to say that the aforementioned embodiments may be applicable only for any one of the pulse dialing method and the DTMF dialing method.

Further, although, in the first embodiment, the first telephone number information group 61 and the second telephone number information group 62 are transmitted to the dial signal monitoring section 32 so that the dial signal monitoring section 32 compares the first telephone number represented by the dial signals with the second telephone number represented by the first and second telephone number information groups 61, 62, it is also applicable that the comparison processing and the controlling operation of the line release can be conducted in anther section, for instance, in the first soft controlling block 40. Concretely speaking, it is also applicable that the first soft controlling block 40 compares a telephone number represented by the dial monitoring information 65 transmitted from the dial signal monitoring section 32 through the second soft controlling block 50 with a telephone number represented by the first telephone number information group 61 and the second telephone number information group 62 designated by the user, and, when both telephone numbers do not coincide with each other, the first soft controlling block 40 outputs a predetermined control demand to the line releasing circuit 31 to release the telephone line from the apparatus.

Still further, although, in the aforementioned embodiment, the comparison processing is conducted to determine whether or not the first telephone number represented by the dial signals coincides with any one of the plurality of telephone numbers registered in the number registration table 66, it is also applicable that the comparison processing is conducted only to determine whether or not the first telephone number coincides with the second telephone number, when the second telephone number in regard to the current calling operation can be specified as only one telephone number concerned.

Incidentally, although, in the aforementioned embodiment, the facsimile apparatus is provided with both the function of releasing the line when determining that the first telephone number does not coincides with the second telephone number and the other function of storing the history of such the line release, it is also applicable that the facsimile apparatus is merely provided with any one of the abovementioned functions. Further, although, in the aforementioned embodiment, the facsimile apparatus and the error call monitoring apparatus to be employed for the facsimile apparatus are described as the embodiments of the present invention, it is needless to say that any kind of facsimile apparatus having both copying and printing functions could be an embodiment of the present invention, as far as the apparatus has the facsimile function.

According to the facsimile apparatus and the error call monitoring apparatus embodied in the present invention, the following effects can be attained.
(1) Since the dial signals actually transmitted onto the telephone line is detected so as to compare the first telephone number represented by the detected dial signals with the second telephone number represented by the telephone number information designated by the user, and when determining that the first telephone number and the second telephone number does not coincide with each other, the telephone line is released from the apparatus, it becomes possible to prevent the facsimile apparatus from transmitting the image information to a wrong receiver.
(2) Since the facsimile apparatus stores the first telephone number represented by the detected dial signals and the second telephone number represented by the telephone number information designated by the user, it becomes possible to provide the information useful for investigating a cause of an event presumably regarded as an error call.

According to the preferred embodiment of the present invention described in the above, the first telephone number, detected by monitoring the dial signals to be actually transmitted onto the telephone line by the facsimile apparatus, is compared with the second telephone number represented by the telephone number information inputted from the telephone number input section designated by the user, and when determining that the first telephone number and the second telephone number does not coincide with each other, the telephone line is released (or disconnected) from the apparatus. The cases, in which the first telephone number actually transmitted onto the telephone line and the second telephone number designated by the user does not coincide with each other, includes (a) a software error occurring in the mid course of the processing until the telephone number information inputted from the telephone number input section are transmitted to the calling circuit, (b) a malfunction of the calling circuit itself, (b) an occurrence of reflections and/or distortions in the dial signals caused by induced components generated from the PBX (Private Branch Exchange) etc., etc.

The telephone number information inputted from the telephone number input section represent the telephone number at the entrance when the user designates the receiver, while the dial signals detected by the dial signals detection section represent the telephone number at the outlet from which the facsimile apparatus transmits the dial signals to the telephone line. Accordingly, by comparing these telephone numbers with each other, it becomes possible to surely detect and prevent the error call, even if the cause of the error call exists at any one of the steps from the entrance to the outlet.

According to the preferred embodiment of the present invention described in the above, the user designates the current receiver by selecting specific telephone number information from the telephone number information stored in advance in the telephone number storage section. For instance, the user designates the current receiver by selecting one-touch key or an abbreviate dial number. The facsimile apparatus compares the first telephone number detected from the dial signals actually transmitted onto the telephone line with the second telephone number represented by the telephone number information selected by the user, and when determining that the first telephone number and the second telephone number does not coincide with each other, the telephone line is released (or disconnected) from the apparatus.

According to the preferred embodiment of the present invention described in the above, the first telephone number, detected by monitoring the dial signals to be actually transmitted onto the telephone line by the facsimile apparatus and the second telephone number represented by the telephone number information inputted from the telephone number input section designated by the user are stored into a storage section, so that the first and second telephone number information are available for investigating the cause of the error call later on.

According to the preferred embodiment of the present invention described in the above, the first telephone number, detected by monitoring the dial signals to be actually transmitted onto the telephone line by the facsimile apparatus and the second telephone number represented by specific telephone number information selected from the telephone number information stored in advance in the telephone number storage section are stored into a storage section.

According to the preferred embodiment of the present invention described in the above, the monitor apparatus (hereinafter, also referred to as an error call monitoring apparatus) compares the first telephone number, detected by monitoring the dial signals to be actually transmitted onto the telephone line by the facsimile apparatus, with the second telephone number represented by the telephone number information acquired from the facsimile apparatus and designated by the user, and when determining that the first telephone number and the second telephone number does not coincide with each other, the telephone line is released (or disconnected) from the apparatus. The monitor apparatus externally coupled to both the facsimile apparatus and the telephone line in such a manner that the monitor apparatus is inserted into a path between the facsimile apparatus and the telephone line.

While the preferred embodiments of the present invention have been described using specific term, such description is for illustrative purpose only, and it is to be understood that changes and variations may be made without departing from the spirit and scope of the appended claims.

What is claimed is:

1. A facsimile apparatus, comprising:
a telephone number input section which accepts an input of telephone number information for a destination;
a dial signals detection section which detects dial signals to be transmitted on a telephone line;
a comparison section which compares a first telephone number represented by the dial signals detected by the dial signals detection section with a second telephone number represented by the telephone number information inputted at the telephone number input section; and
a control section which disconnects the telephone line based on a comparison result of the comparison section in case that the first telephone number and the second telephone number are different.

2. The facsimile apparatus of claim 1, further comprising:
a notification section which notifies a user that the telephone line is disconnected.

3. The facsimile apparatus of claim 2, wherein the notification section displays on an operation display section that the telephone line is disconnected.

4. The facsimile apparatus of claim 2, wherein the notification section sends e-mail to the user.

5. The facsimile apparatus of claim 1, wherein the control section disconnects the telephone line before image information is transmitted to a destination represented by the dial signals.

6. The facsimile apparatus of claim 1, further comprising:
a storage section which stores the first telephone number and the second telephone number.

7. The facsimile apparatus of claim 6, wherein the control section controls to store the second telephone number or both the first telephone number and the second telephone number in association with each transmission as a record.

8. The facsimile apparatus of claim 6, wherein the control section controls to store the comparison result of the comparison section in association with the second telephone number.

9. The facsimile apparatus of claim 1, further comprising:
a telephone number storage section which stores destination information and telephone number information in association with each other; and
a selection section which selects desired telephone number information from the telephone number information stored in the telephone number storage section,
wherein the comparison section compares a first telephone number represented by the dial signals detected by the dial signals detection section with a second telephone number represented by the telephone number information inputted at the telephone number input section or by the telephone number information selected at the selection section.

10. A facsimile apparatus, comprising:
a telephone number storage section which stores destination information and telephone number information in association with each other;
a selection section which selects desired telephone number information from the telephone number information stored in the telephone number storage section;
a dial signals detection section which detects dial signals to be transmitted on a telephone line;
a comparison section which compares a first telephone number represented by the dial signals detected by the dial signals detection section with a second telephone number represented by the telephone number information selected at the selection section; and
a control section which disconnects the telephone line based on a comparison result of the comparison section in case that the first telephone number and the second telephone number are different.

11. The facsimile apparatus of claim 10, further comprising:
a notification section which notifies a user that the telephone line is disconnected.

12. The facsimile apparatus of claim 11, wherein the notification section displays on an operation display section that the telephone line is disconnected.

13. The facsimile apparatus of claim 11, wherein the notification section sends e-mail to the user.

14. The facsimile apparatus of claim 10, wherein the control section disconnects the telephone line before image information is transmitted to a destination represented by the dial signals.

15. The facsimile apparatus of claim 10, further comprising:
a storage section which stores the first telephone number and the second telephone number.

16. The facsimile apparatus of claim 15, wherein the control section controls to store the second telephone number or both the first telephone number and the second telephone number in association with each transmission as a record.

17. The facsimile apparatus of claim 15, wherein the control section controls to store the comparison result of the comparison section in association with the second telephone number.

18. A facsimile apparatus, comprising:
a telephone number input section which accepts an input of telephone number information for a destination;
a dial signals detection section which detects dial signals to be transmitted on a telephone line;
a control section which controls to store a first telephone number represented by the dial signals detected by the dial signals detection section and a second telephone number represented by the telephone number information inputted at the telephone number input section.

19. The facsimile apparatus of claim 18, wherein the control section controls to store the second telephone number or both the first telephone number and the second telephone number in association with each transmission as a record.

20. The facsimile apparatus of claim 18, further comprising:
a telephone number storage section which stores destination information and telephone number information in association with each other; and
a selection section which selects desired telephone number information from the telephone number information stored in the telephone number storage section, wherein the control section controls to store a first telephone number represented by the dial signals detected by the dial signals detection section and a second telephone number represented by the telephone number information inputted at the telephone number input section or the telephone number information selected at the selection section.

21. A facsimile apparatus, comprising:
a telephone number storage section which stores destination information and telephone number information in association with each other; and
a selection section which selects desired telephone number information from the telephone number information stored in the telephone number storage section,
a dial signals detection section which detects dial signals to be transmitted on a telephone line;
a control section which controls to store a first telephone number represented by the dial signals detected by the dial signals detection section and a second telephone number represented by the telephone number information selected at the selection section.

22. The facsimile apparatus of claim 21, wherein the control section controls to store the second telephone number or both the first telephone number and the second telephone number in association with each transmission as a record.

23. A monitor apparatus for an error call request, comprising:
a telephone number obtaining section which obtains from a facsimile apparatus telephone number information for a destination;
a dial signals detection section which detects dial signals to be transmitted from the facsimile apparatus to a telephone line;
a comparison section which compares a first telephone number represented by the dial signals detected by the dial signals detection section with a second telephone number represented by the telephone number information obtained at the telephone number obtaining section; and
a control section which disconnects the telephone line based on a comparison result of the comparison section in case that the first telephone number and the second telephone number are different.

24. The monitor apparatus of claim 23, further comprising:
a notification section which notifies a user that the facsimile apparatus is disconnected with the telephone line.

25. The monitor apparatus of claim 23, wherein the control section disconnects the telephone line before image information is transmitted from the facsimile apparatus to a destination represented by the dial signals.

26. The monitor apparatus of claim 23, further comprising:
a storage section which stores the first telephone number and the second telephone number.

27. The monitor apparatus of claim 26, wherein the control section controls to store the second telephone number or both the first telephone number and the second telephone number in association with each transmission as a record.

28. The monitor apparatus of claim 26, wherein the control section controls to store the comparison result of the comparison section in association with the second telephone number.

29. A monitor apparatus for an error call request, comprising:
a telephone number obtaining section which obtains from a facsimile apparatus telephone number information for a destination;
a dial signals detection section which detects dial signals to be transmitted from the facsimile apparatus to a telephone line;
a control section which controls to store a first telephone number represented by the dial signals detected by the dial signals detection section with a second telephone number represented by the telephone number information obtained at the telephone number obtaining section.

30. The monitor apparatus of claim 29, wherein the control section controls to store the second telephone number or both the first telephone number and the second telephone number in association with each transmission as a record.
